(19) United States
(12) Patent Application Publication
(10) Pub. No.: US 2009/0283666 A1
(43) Pub. Date: Nov. 19, 2009

(54) Light Scanning Photoelectric Switch

(75) Inventor: Tsuyoshi Tagashira, Osaka (JP)

Correspondence Address: KILYK & BOWERSOX, P.L.L.C., 400 HOLIDAY COURT, SUITE 102, WARRENTON, VA, 20186, US

(73) Assignee: KEYENCE CORPORATION, Osaka (JP)

(21) Appl. No.: 12/426,993

(22) Filed: Apr. 21, 2009

(30) Foreign Application Priority Data
May 14, 2008 (JP) 2008-126625

(51) Int. Cl. H01J 40/14

(52) U.S. Cl. 250/216

(57) ABSTRACT

Provided is a light scanning photoelectric switch that can be attached to a cover correctly even by an inexperienced person. The light scanning photoelectric switch includes: a casing that contains a light scanning unit and a photoelectric transducer and has an opening substantially in U-shape in cross section perpendicular to an axis; a cover that is detachably provided for the casing and is for covering the opening of the casing; an elastically deformable sealing member provided between the casing and the cover; an engagement unit provided for the cover and the casing so that the cover engages with the casing in a state in which the sealing member is compressed in an attachment direction along which the cover is attached to the casing; and a fixation portion capable of receiving a fixing member that compresses the sealing member in a direction different from the attachment direction in a state in which the cover engages with the casing.

### CROSS-REFERENCE TO RELATED APPLICATIONS

The present application claims foreign priority based on Japanese Patent Application No. 2008-126625, filed May 14, 2008, the contents of which is incorporated herein by reference.

### BACKGROUND OF THE INVENTION

1. Field of the Invention

The present invention relates to a light scanning photoelectric switch.

2. Description of the Related Art

Conventionally, there has been proposed a scanning device that detects, using light such as laser, whether or not an object is present within a predetermined area that has been previously set (see Japanese Unexamined Patent Publication No. 4-310890 (Abstract), Japanese Unexamined Patent Publication No. 3-175390 (FIG. 1), and U.S. Pat. No. 5,455,669 (FIG. 4)).

A light scanning photoelectric switch is a so-called safety scanner or safety laser scanner, and scans over a detection area with light such as laser, receives the scanning light that has been reflected within the detection area, measures a distance to an object based on a difference between a light projecting timing and a light receiving timing, that is, a time difference and a known speed of light, specifies a position of the object based on a distance in each predetermined direction, outputs a safety signal indicating that a function of the device is either enabled or disabled, and disables the function of the device as needed.

FIGS. 16A and 16B illustrate one example of a conventional light scanning photoelectric switch.

In FIGS. 16A and 16B, a photoelectric switch of a light scanning type is provided with packing 102 between a casing 100 and a front cover 101 for airtightness.

On the other hand, the front cover 101 is a consumable goods, and an inexperienced user who is not familiar with a structure of the device exchanges the front cover 101. In a case of this switch, since the front cover 101 is in U-shape, tightening of screws can be uneven depending on an attachment order of fixing screws to the front cover 101, resulting in a defect in airtightness.

For example, when tightening the screws on diagonally forward sides F1, F2 after tightening the screws on both sides S1, S2, both ends of the cover 101 in U-shape are fixed to the casing 100 by the screws on the sides S1, S2 that have been tightened first, and accordingly, it is not possible to compress the packing 102 by thereafter tightening the screws on the diagonally forward sides F1, F2. In this case, a defect in airtightness could occur. In particular, because a thickness and a width of the packing 102 used for the light scanning photoelectric switch becomes smaller in size as the size of the switch becomes smaller, a defect in airtightness can easily occur.

### SUMMARY OF THE INVENTION

In view of the above, an object of the present invention is to provide a light scanning photoelectric switch with which a defect in airtightness does not easily occur even when an inexperienced person exchanges a cover.

In order to achieve the above object, a light scanning photoelectric switch of the present invention includes: a light scanning unit that rotates about a predetermined axis and scans scanning light over a detection area; a photoelectric transducer that receives the scanning light that has been reflected on an object within the detection area, and generates a light receiving signal that corresponds to the received scanning light; a recognition unit that calculates an irradiation direction of the received scanning light and a distance to the object based on the light receiving signal for the irradiation direction, and recognizes a position of the object based on the calculated irradiation direction and distance; a determination unit that determines whether or not the object is present within a protection area that has been previously set, and outputs a safety signal based on a result of the determination; a casing that contains the light scanning unit and the photoelectric transducer and includes an optical path of the scanning light from the light scanning unit to the detection area, the casing having an opening substantially in U-shape in cross section perpendicular to the axis; a cover that is detachably provided for the casing and is for covering the opening of the casing; an elastically deformable sealing member that is provided between the casing and the cover; an engagement unit formed at the cover and the casing so that the cover engages with the casing in a state in which the sealing member is compressed in an attachment direction along which the cover is attached to the casing; and a fixation portion capable of receiving a fixing member that compresses the sealing member in a direction different from the attachment direction in a state in which the cover engages with the casing.

According to the present invention, when the cover is attached to the casing, the cover is engaged with the casing in the attachment direction by the engagement unit. This brings the sealing member into a state in which the sealing member is compressed between the cover and the casing in the attachment direction of the cover. When the cover is fastened by the fixing member in a second direction different from the attachment direction of the cover in this state, the sealing member is compressed between the cover and the casing in the second direction. Thus, according to the present invention, as the sealing member can be compressed in two directions and the fixing member is not required to be fastened in the attachment direction, the order of fastening the fixing member cannot be mistaken, thereby preventing uneven tightening by the fixing member.

Further, providing the engagement unit allows correct positioning of the cover in the attachment direction.

Therefore, it is possible to exchange the cover correctly even by an inexperienced person.

As used herein, the detection area refers to an area in which the presence of the object can be detected by receiving the scanning light reflected on the object, and is defined by the distance to the object and a range of scanning with the scanning light. This detection area is previously set by a user for each device. The protection area is previously set and recorded in a predetermined recording unit for each spot at which the switch of the present invention is used in the detection area.

In other words, the detection area is defined by a boundary of a range in which the presence of the object can be recognized without fail, while the protection area is an area in which safety of workers and external devices must be ensured.

In the present invention, it is preferable that the cover includes the front portion that is substantially semicircular in cross section and the pair of side portions continuous from the front portion, and the engagement unit is formed at each of the side portions.

According to this aspect of the present invention, it is possible, by the engagement unit formed at the side portion, to temporarily fix the cover by compressing the sealing member in an attachment direction.

In the present invention, it is preferable that the fixation portion is formed at each of the side portions.

According to this aspect of the present invention, it is possible to compress and fix the sealing member in the direction different from the attachment direction by screwing the fixing member into the fixation portion formed at the side portion.

In the present invention, it is preferable that the cover is substantially in U-shape in cross section, and the fixation portion is formed in vicinity of either end of the substantial U-shape.

According to this aspect of the present invention, forming the fixation portion in vicinity of the either end of the cover substantially in U-shape facilitates an effect of the compression by the fixation portion to the sealing member, and it is possible to easily provide a space at which the fixation portion is formed.

In the present invention, it is preferable that in a state in which the cover is not fixed by the fixing member, both of the side portions of the cover may be pressed against the sealing member in the different direction.

According to this aspect of the present invention, the both side portions of the cover are pressed against the sealing member in the state in which the cover is not fixed by the fixing member. Accordingly, it is possible to further prevent the uneven tightening of the fixing member when fixing the cover by the fixing member, and the cover can be correctly fixed with the fixing member even by an inexperienced person.

In the present invention, it is preferable that the first and second flanges for improving bending rigidity of the cover are formed respectively in vicinity of the first and second ends of the axis of the cover, and the portion of the engagement unit is formed on the cover by cutting out the flange or the side portion near the flange.

According to this aspect of the present invention, forming the first and second flanges can prevent a strength reduction of the cover due to the cutting out of the side portions.

### BRIEF DESCRIPTION OF THE DRAWINGS

FIG. 1 is a schematic perspective view illustrating an optical system of a light scanning photoelectric switch according to a first embodiment of the present invention;

FIG. 2A is a schematic configurational view illustrating the light scanning photoelectric switch and FIG. 2B is a schematic plan view illustrating a detection area and a protection area of the light scanning photoelectric switch;

FIG. 3 is a schematic perspective view illustrating the light scanning photoelectric switch;

FIG. 4A is a schematic right side view and FIG. 4B is a schematic perspective view from bottom right, illustrating the light scanning photoelectric switch;

FIG. 5 is an exploded perspective view illustrating the light scanning photoelectric switch;

FIG. 6 is a schematic perspective view illustrating the light scanning photoelectric switch with a cover and a sealing member thereof being dismounted;

FIG. 7 is a schematic vertical cross-sectional view illustrating the light scanning photoelectric switch;

FIG. 8 is a schematic right side view illustrating a device main body of the light scanning photoelectric switch;

FIG. 9 is a schematic vertical cross-sectional view illustrating the device main body of the light scanning photoelectric switch;

FIG. 10A is a schematic cross-sectional view illustrating an upper portion of the device main body viewed from the bottom and FIG. 10B is a cross-sectional view taken along line XB-XB of the upper portion of the device main body;

FIG. 11 is a schematic perspective view of the light scanning photoelectric switch viewed from the bottom with the cover and the sealing member being dismounted;

FIG. 12 is an enlarged schematic perspective view partially illustrating an engagement unit and a fixation portion;

FIG. 13 is an enlarged schematic perspective view partially illustrating the engagement unit and the fixation portion;

FIGS. 14A and 14B are schematic cross-sectional views illustrating an engagement state of the cover and a casing;

FIGS. 15A, 15B and 15C are schematic top sectional views illustrating a method of attaching the cover; and

FIGS. 16A and 16B are schematic perspective views illustrating a conventional light scanning photoelectric switch and packing.

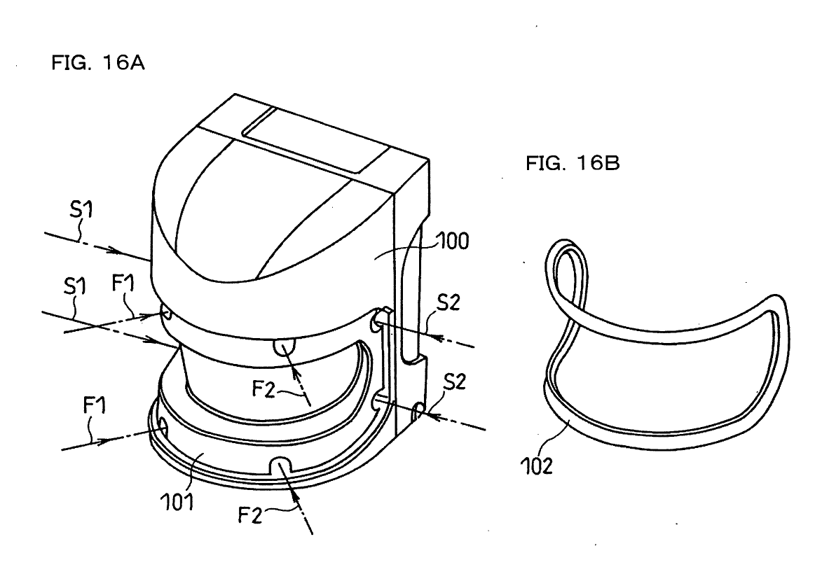

### DETAILED DESCRIPTION OF THE PREFERRED EMBODIMENTS

### First Embodiment

Hereinafter, one embodiment of the present invention will be described with reference to the drawings.

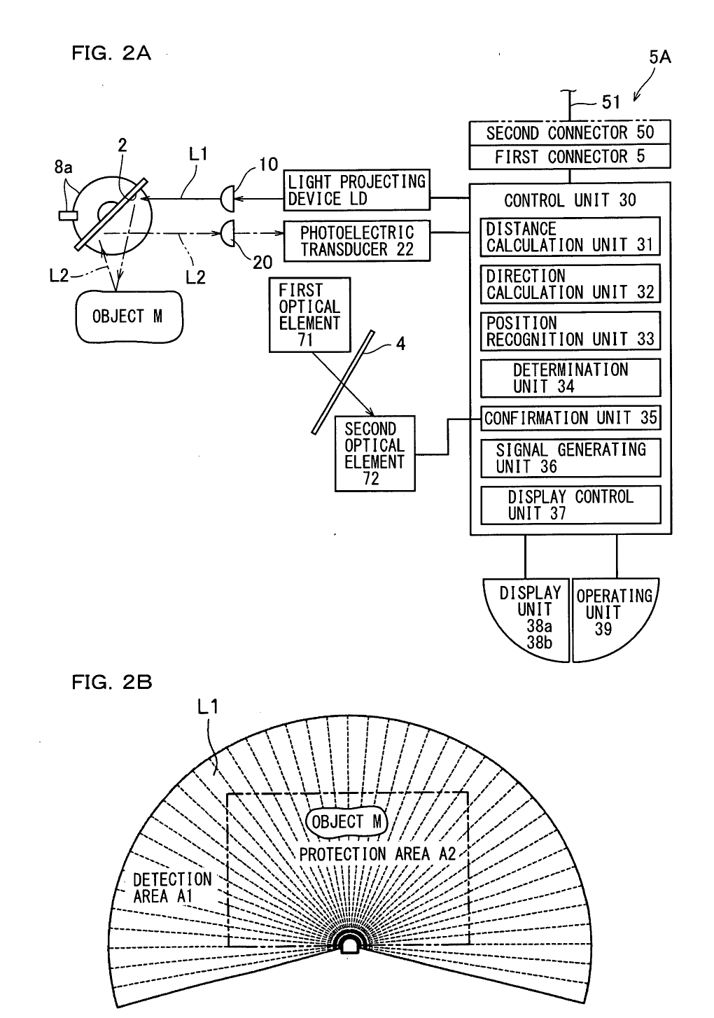

A light scanning photoelectric switch according to the present embodiment, for example, is connected to an external device such as a robot, and outputs a safety signal indicating that operation of the connected external device is either enabled or disabled. For example, when an object M such as a human body is detected within a protection area A2 that has been previously set as shown in FIG. 2B, the photoelectric switch of the present embodiment, in a predetermined mode, outputs an operation disable signal to prohibit (disable) the operation of the external device connected to the photoelectric switch. The protection area A2 is previously set within a detection area A1 and recorded.

### Optical Path

The photoelectric switch of the present embodiment detects the object M by, for example, scanning light such as a laser beam. An optical system is first described.

Light Irradiating Unit

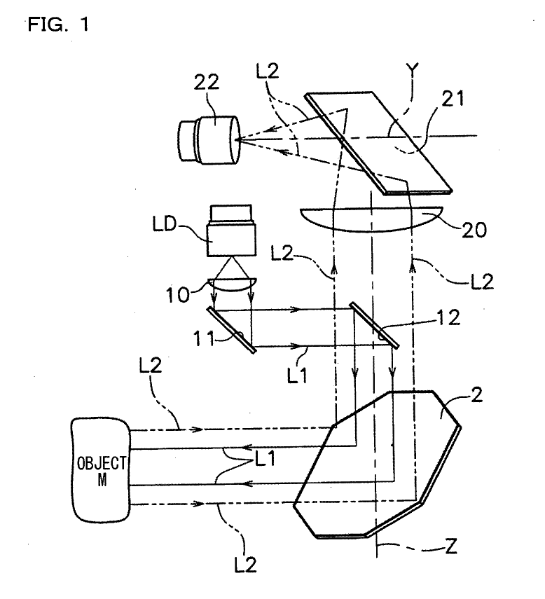

As shown in FIG. 1, light L1 constituted from a laser beam projected from a light projecting device LD travels through a light projecting lens 10, and is deflected by first and second light projecting mirrors (reflecting mirrors) 11, 12 and applied along a predetermined first axis Z. Thus, the light projecting lens 10 and the first and second light projecting mirrors 11, 12 constitute a light irradiating unit that projects the light L1 along the first axis Z.

Light Scanning Unit 2

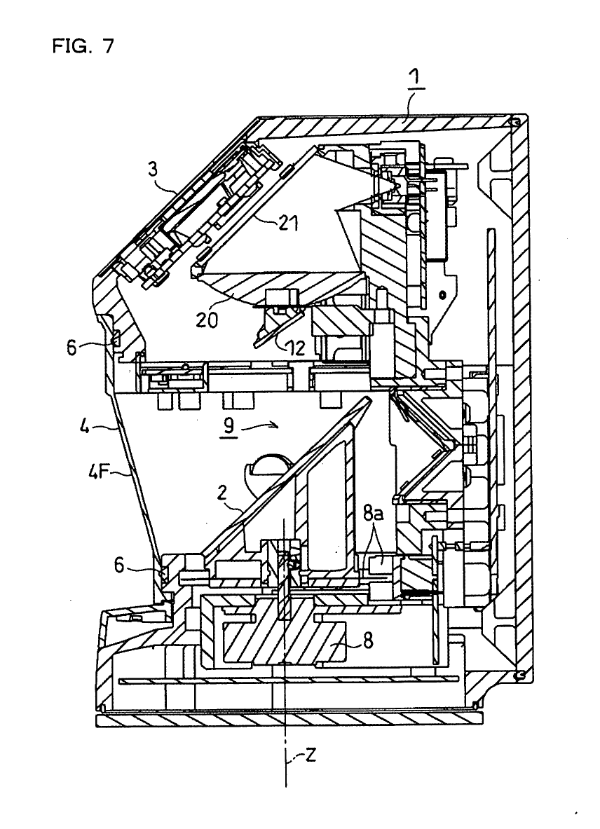

The light L1 reflected on the second light projecting mirror 12 is directed toward and applied on a light scanning unit 2. The light scanning unit 2 is constituted from a mirror that rotates about the first axis Z and is disposed so as to be angled substantially at 45 degrees to the first axis Z. The light scanning unit 2 is driven to rotate by a motor 8 as shown in FIG. 7, thereby deflecting the light L1 that has been applied by the irradiating unit toward a plane perpendicular to the first axis Z and scanning the light L1 across the plane, as shown by a dashed line in FIG. 2B. The scanning light L1 that has been deflected by the light scanning unit 2 is scanned across and applied on the detection area A1 shown in FIG. 2B by the light scanning unit 2 being driven to rotate.

When the object M is present within the detection area Al, the light scanning unit 2 deflects the scanning light L1 (hereinafter referred to as “reflecting light L2”) that has been reflected on the object M along the first axis Z as shown in FIG. 1.

Light Receiving Reflecting Body 21 and Photoelectric Transducer 22

The reflecting light L2 deflected by the light scanning unit 2 is collected by a light receiving lens 20. The light receiving lens 20 has a light axis that is coincident with the first axis Z, and the reflecting light L2 collected by the light receiving lens 20 is deflected by a light receiving reflecting body 21, and collected by a photoelectric transducer 22.

The light receiving reflecting body 21 is disposed so as to be angled substantially at 45 degrees to the first axis Z, and to deflect a light axis of the reflecting light L2 collected by the light receiving lens 20 in a second axis Y that is substantially perpendicular to the first axis Z, and collects the light at the photoelectric transducer 22.

The photoelectric transducer 22 receives the reflecting light L2 that has been deflected by the light receiving reflecting body 21, and photoelectrically converts the received reflecting light L2 to generate a light receiving signal.

### Device Configuration

As shown in FIG. 2A, the light projecting device LD and the photoelectric transducer 22 are connected to a control unit 30.

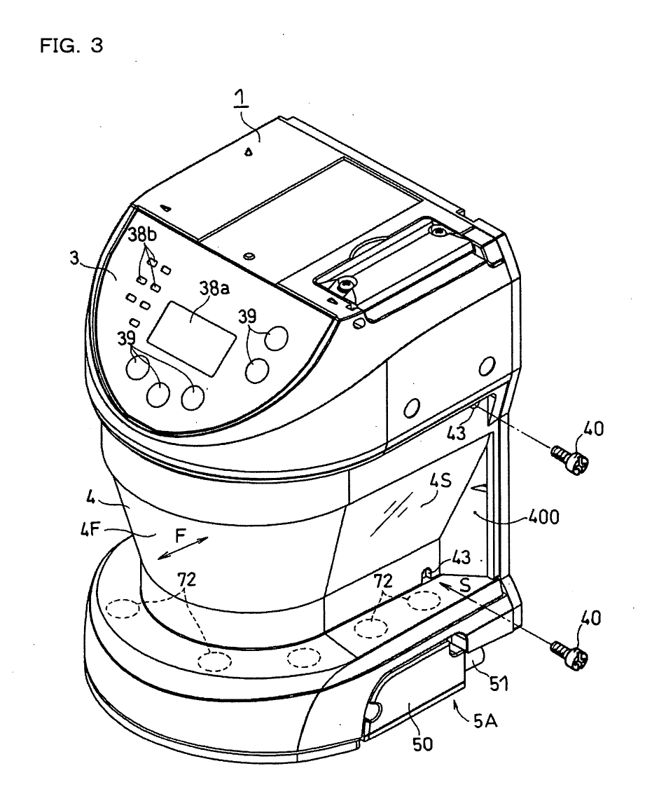

The control unit 30 is connected with, as shown in FIG. 3, a liquid crystal display 38a and an LED (Light Emitting Diode) 38b for indicating various status of the photoelectric switch, as well as an operating unit 39 for setting the protection area A2 and the like.

On the other hand, a first connector 5 is connected to the control unit 30 shown in FIG. 2. To the first connector 5, a cable 5A having a second connector which is connected to the external device is connected. The cable 5A having a second connector includes a second connector 50 at an end of a cable portion 51.

The control unit 30 is provided with a distance calculation unit 31, a direction calculation unit 32, a position recognition unit 33, a determination unit 34, a confirmation unit 35, a signal generating unit 36, a display control unit 37, and the like.

Direction Calculation Unit 32

The direction calculation unit 32 calculates an irradiation direction (deflect direction) of the scanning light L1 deflected toward the detection area A1 by the light scanning unit 2 and a direction along which the reflecting light L2 from the object M enters when projecting and receiving the light.

Here, a rotation shaft of the motor 8 shown in FIG. 7 is provided with, for example, a photoelectric rotary encoder 8a. The deflect directions of the light L1 and L2 can be obtained by calculating an angle of rotation of the light scanning unit 2 based on an output from the rotary encoder 8a.

Distance Calculation Unit 31

The distance calculation unit 31 calculates a distance to the object M in each deflect direction based on the light receiving signal from the photoelectric transducer 22. Specifically, the distance to the object M is calculated by multiplying a difference between a light projecting timing of the scanning light L1 from the light projecting device LD and a light receiving timing of the photoelectric transducer 22 that has received the reflecting light L2 reflected on the object M, by the known speed of light. The calculation of the distance based on the light projecting and receiving timings is repeated at a predetermined interval of short period of time.

Position Recognition Unit 33

The position recognition unit 33 shown in FIG. 2A recognizes a position of the object M. Specifically, the position recognition unit 33 recognizes the position of the object M by calculating the position of the object M based on the deflect direction calculated by the direction calculation unit 32 and the distance to the object M in this deflect direction calculated by the distance calculation unit 31 for each of the light projecting and receiving timings.

The distance calculation unit 31, the direction calculation unit 32, and the position recognition unit 33 constitute a recognition unit of the present invention.

Determination Unit 34

The determination unit 34 determines whether or not the object M is present within the protection area A2 that has been previously set based on the position of the object M calculated by the position recognition unit 33.

First and Second Optical Elements 71, 72

Here, a casing 1 of the photoelectric switch is provided with a transparent front cover 4 as shown in FIG. 3 that transmits the scanning light L1 and the reflecting light L2. For example, an amount of the reflecting light L2 that enters the photoelectric transducer 22 shown in FIG. 2A decreases if the cover 4 is obscured by dirt or the like, and therefore sensitivity in detecting the position of the object M is degraded.

As used herein, “transparent” means transmissive to a wavelength of the scanning light L1. When the scanning light L1 is infrared light, the front cover 4 is transparent to the wavelength of infrared light.

In view of the above problem, a plurality of first and second optical elements 71, 72 for monitoring a status of the cover 4 shown in FIG. 2A are provided and these elements constantly monitor the status of the cover 4. The first and second optical elements 71, 72 are disposed so as to face each other with the cover 4 interposed therebetween, and light from the first optical element 71 passes through the cover 4 and enters the second optical element 72, which transmits the status of the cover 4 as a part of the optical path to the control unit 30.

Confirmation Unit 35

The confirmation unit 35 monitors its own status including the status of the cover 4 sent from the second optical element 72, and confirms the own status is a safety status. Specifically, the confirmation unit 35 constitutes a failure detection unit that detects whether or not there is a failure in the photoelectric switch, that is, a unit that confirms whether or not the status is sufficiently safe to carry out the desired detection and the like. When the confirmation unit 35 determines that the photoelectric switch is in failure, such a status is displayed in the liquid crystal display 38a and the LED 38b, and the operation disable signal is transmitted to the external device via the signal generating unit 36.

Further, when the confirmation unit 35 determines based on the signal from the second optical element 72 that the cover 4 is deteriorated and requires replacement, the control unit 30 has such a status be displayed in the liquid crystal display 38a and the LED 38b.

Although the above example describes the case in which the first optical element and the second optical element are disposed so as to face each other with the cover 4 interposed therebetween, the present invention is not limited thereto. For example, a mirror as a third optical element can be disposed in place of the second optical element 72, and the second optical element 72 is disposed near the first optical element 71. In this case, the light projected from the first optical element 71 passes through the cover 4 to reflect upon the mirror as the third optical element, and the reflected light again passes through the cover 4 so that the second optical element 72 receives the light.

Signal Generating Unit 36

The signal generating unit 36 generates a safety signal based on a result of the determination by the determination unit 34. For example, in a predetermined mode, when a normal operation of the switch can be confirmed and when the determination unit 34 determines the object M is not present within the protection area A2, the signal generating unit 36 generates a function enable signal as a safety signal. The generated signal is transmitted from the control unit 30 to the external device via the first connector 5, thereby allowing the external device to operate.

### Casing 1

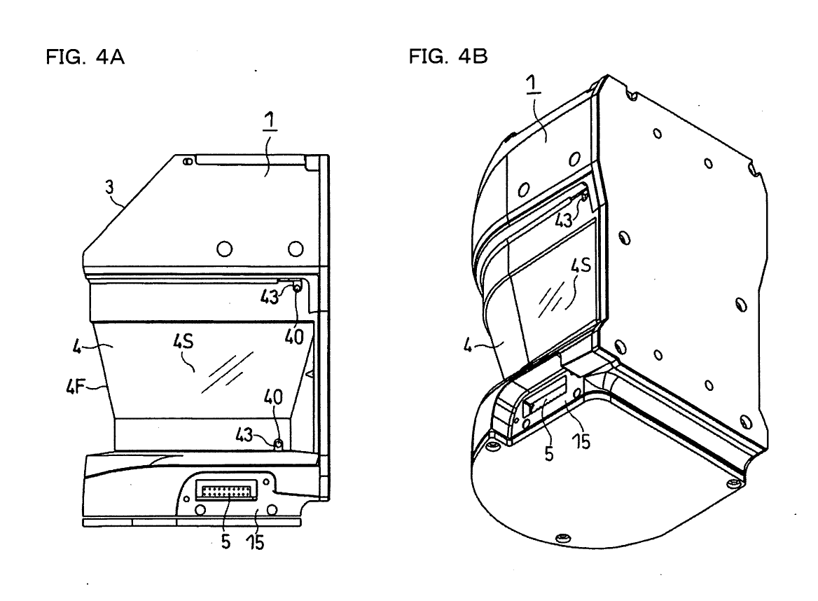

As shown in FIG. 3 and FIGS. 4A and 4B, the photoelectric switch is provided with the casing 1, a display operation panel 3, and the cover 4.

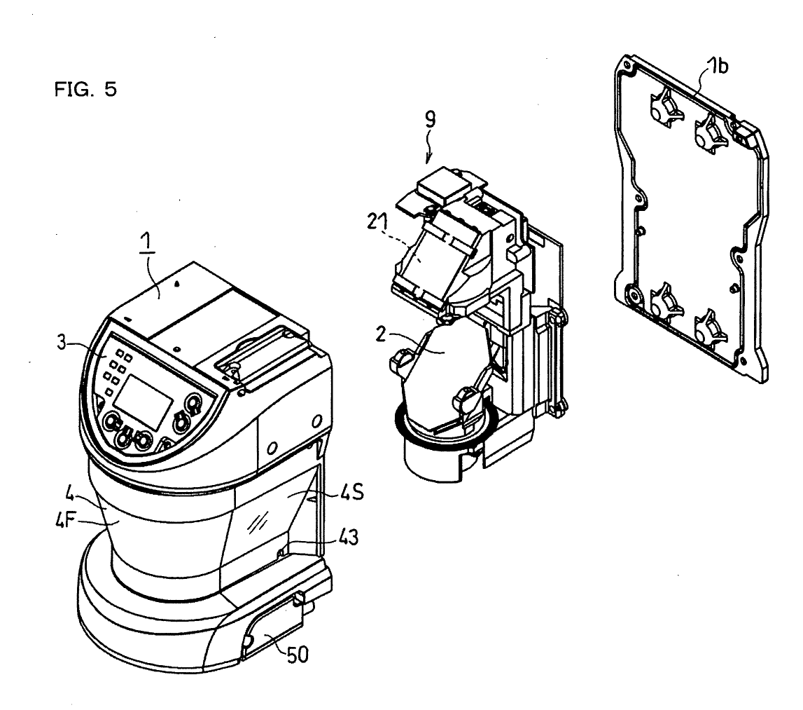

As shown in FIG. 5, the photoelectric switch is provided with a device main body 9 constituted from a configuration device including the optical system described above and a rear cover 1b as a part of the casing 1. The device main body 9 is attached and fixed within the casing 1, and a rear side thereof is sealed by the rear cover 1b.

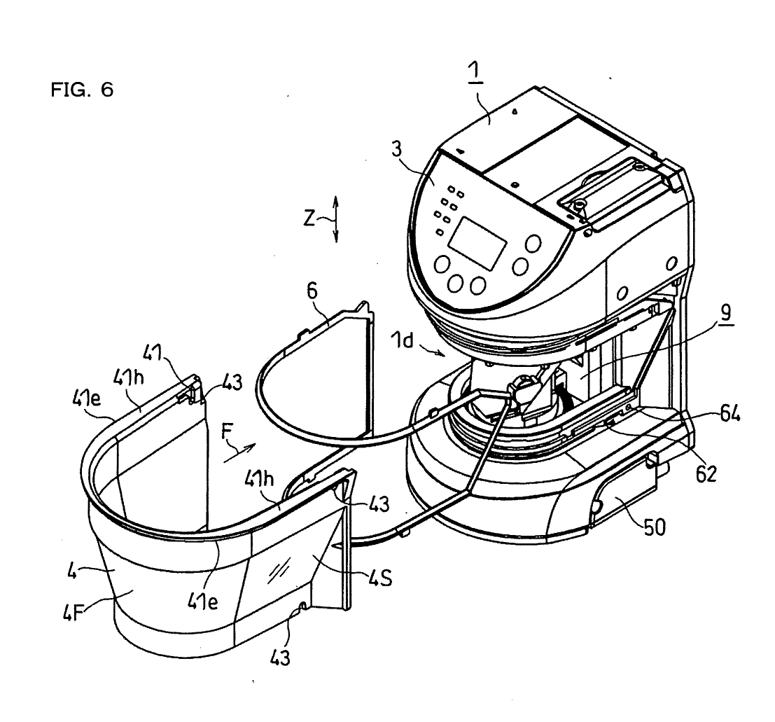

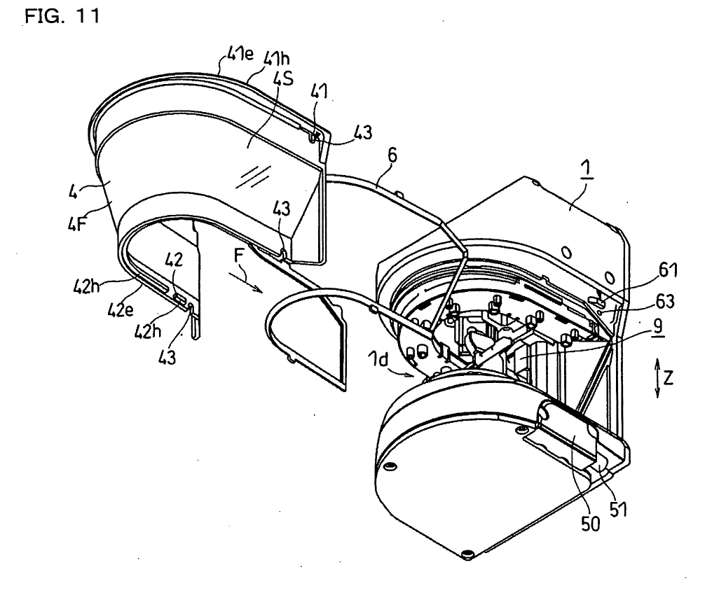

As shown in FIG. 6 (and in FIG. 11), the casing 1 is provided with an opening 1d. The opening 1d includes the optical path from the light scanning unit 2 to the detection area A1 (FIG. 2B), and is substantially in U-shape in a cross section that is perpendicular to the first axis Z (FIG. 7).

At the opening 1d, the cover 4 is detachably provided for the casing 1 so as to cover the opening 1d of the casing 1. An elastically deformable sealing member 6 is interposed between the casing 1 and the cover 4.

Device Main Body 9

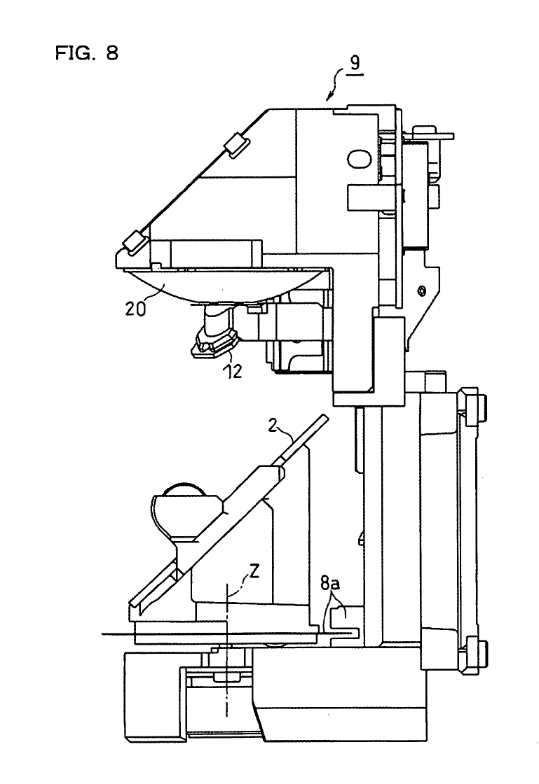

As shown in FIG. 7, the motor 8 for rotating the light scanning unit 2 about the first axis Z is provided below the light scanning unit 2. As shown in FIG. 8, the rotation shaft of the motor 8 is provided with the rotary encoder 8a.

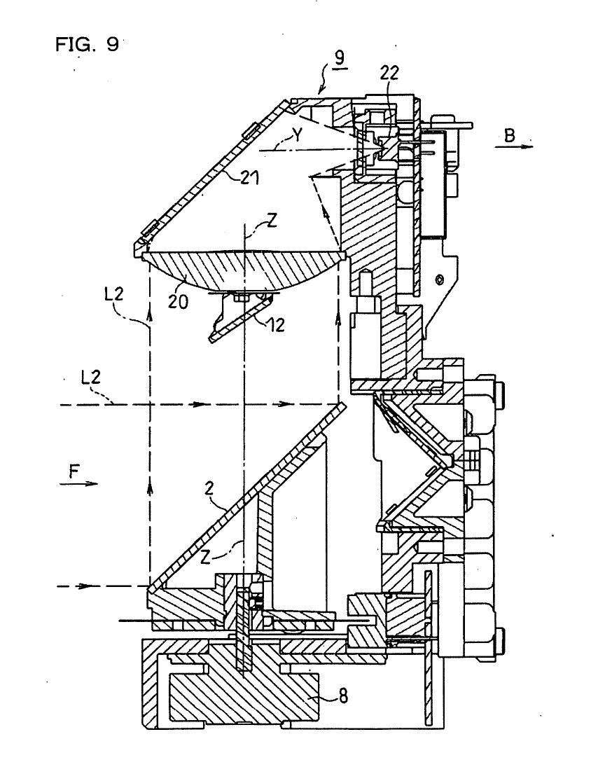

As shown in FIG. 9, the light receiving reflecting body 21 is disposed so as to be angled substantially at 45 degrees to the first axis Z. The light axis of the reflecting light L2 that has been collected by the light receiving lens 20 is deflected in a direction along the second axis Y that is substantially perpendicular to the first axis Z at a center of a solid angle of the reflecting light L2, and collected to the photoelectric transducer 22 provided on a rear side B of the device main body 9.

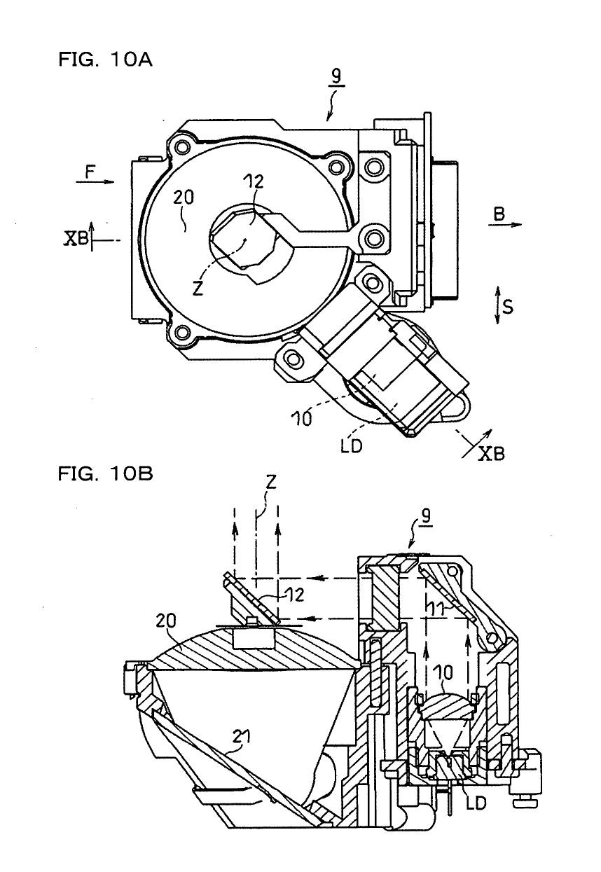

As shown in FIGS. 10A and 10B, the second light projecting mirror 12 is attached substantially at a center of the axis Z of the light receiving lens 20.

Cover 4

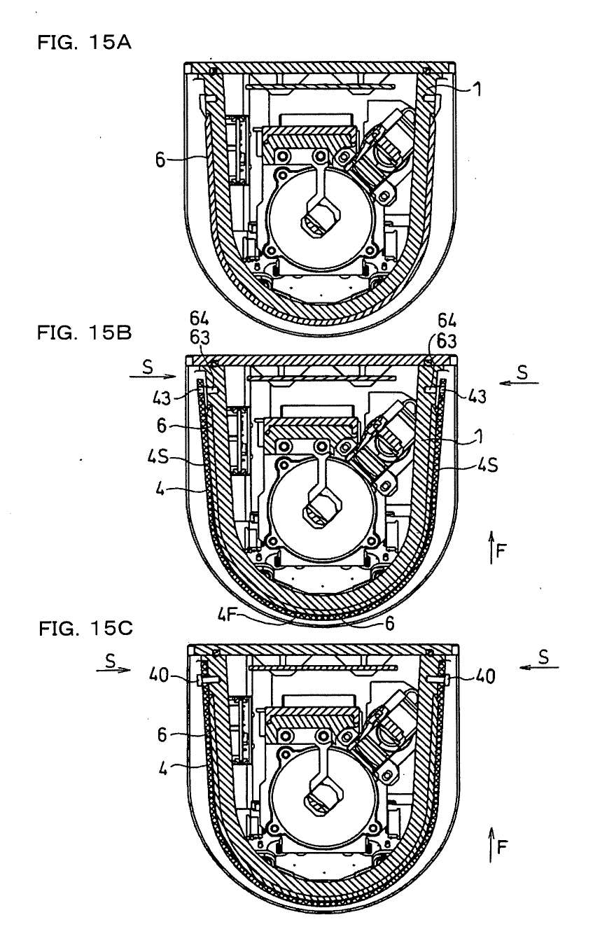

As shown in FIG. 15B, the cover 4 includes a substantially semicircular front portion 4F and a pair of side portions 4S that continue to the front portion 4F in the cross section (the cross section that is perpendicular to the axis Z), and is substantially in U-shape in the cross section. It should be noted that the cover 4 is elastically deformable and formed by transparent synthetic resin.

As shown in FIG. 11, first and second flanges 41h, 42h that improve bending rigidity of the cover 4 are respectively formed in vicinity of first end and ends 41e, 42e in the direction of the axis Z of the cover 4. The first flange 41h is provided continuously from the side portion 4S to the front portion 4F shown in FIGS. 6 and 11.

The second flange 42h shown in FIG. 11 is partially cut out to form a part of an engagement unit that will be described below.

Engagement Unit

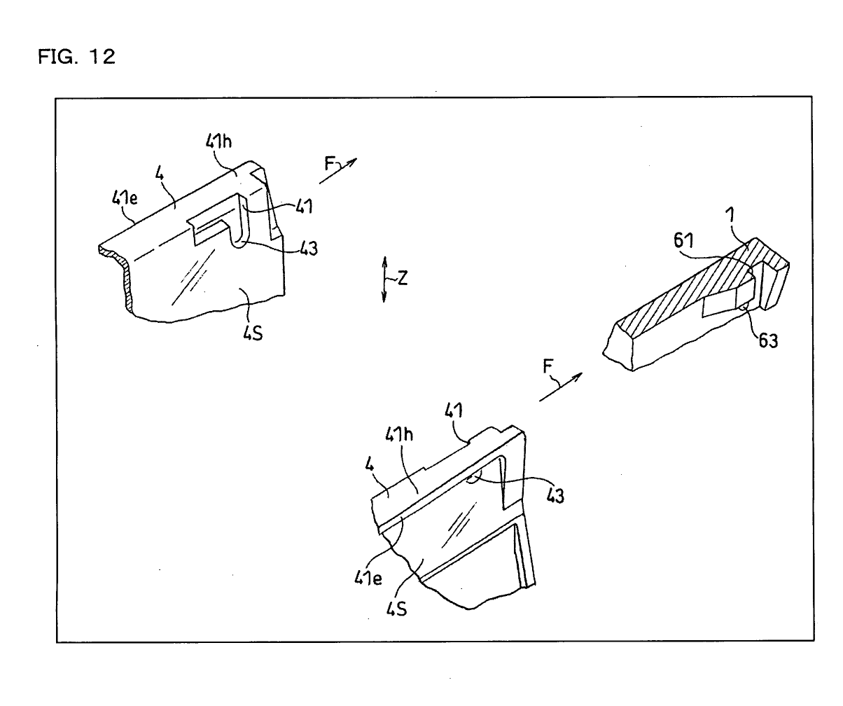

As shown enlarged in FIG. 12, a first engagement portion 41 for being engaged is provided at an upper tip end (first end 41e) of the cover 4 shown in FIG. 6 in the direction of the first axis Z, by cutting out the side portion 4S of the cover 4. At a lower portion of the first engagement portion 41, a screw hole 43 through which a screw member (fixing member) 40 (FIG. 3) is inserted is provided continuously from the cut out portion of the first engagement portion 41.

On the other hand, a first engaging portion 61 that engages with the first engagement portion 4 is provided protruding at a position corresponding to the first engagement portion 41 of the casing 1. The casing 1 is provided with a female screw 63, with which the screw member 40 is screwed to the casing 1 through the screw hole 43.

Thus, the screw hole 43 and the female screw 63 constitute a fixation portion for allowing to receive the screw member 40 (FIG. 3).

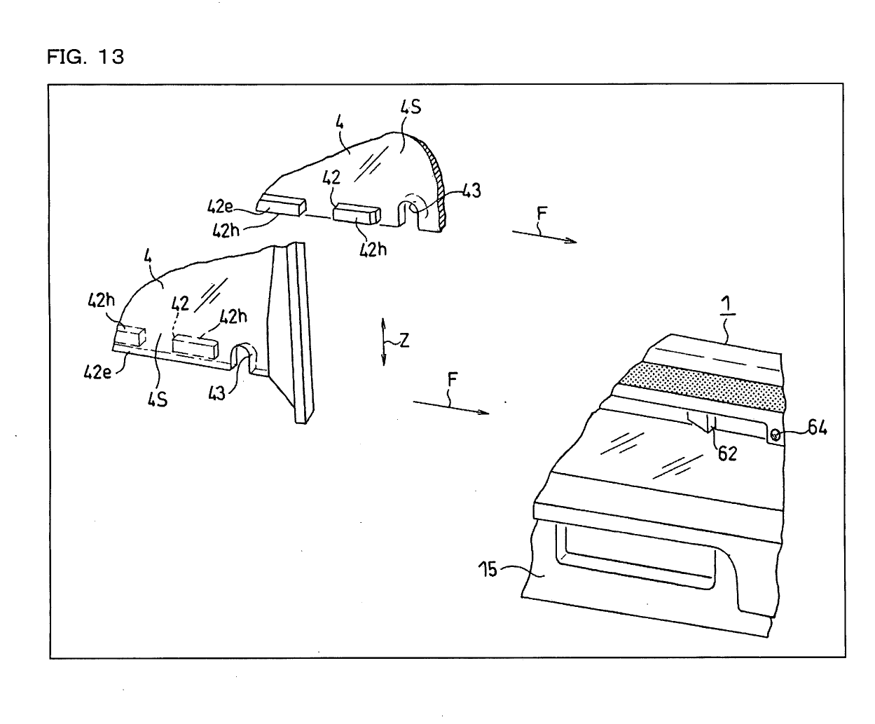

As shown enlarged in FIG. 13, the second flange 42h and a second engagement portion 42 formed by cutting out is provided at a lower tip end (second end 42e) of the cover 4 shown in FIG. 11 in the direction of the first axis Z. The cover 4 is cut out in vicinity of the second engagement portion 42, and the screw hole 43 through which the screw member 40 (FIG. 3) is inserted is provided.

On the other hand, a second engaging portion 62 that engages with the second engagement portion 42 is provided protruding at a position corresponding to the second engagement portion 42 the casing 1. The casing 1 is provided with a female screw 64 with which the screw member 40 is screwed through the screw hole 43.

Thus, the screw hole 43 and the female screw 64 constitute the fixation portion for allowing to receive the screw member 40 (FIG. 3).

The first engagement portion 41, the second engagement portion 42, and the screw holes 43 and 43 shown in FIGS. 12 and 13 are formed at each of the side portions 4S and 4S of the cover 4. As shown in FIG. 15B, the screw holes 43 and 43 and the female screws 63 and 64 are provided in vicinity of the respective side ends of the cover 4 substantially in U-shape.

Attachment Method of Cover 4

In order to attach the cover 4 to the casing 1 shown in FIG. 15A, first, the cover 4 is pushed in an attachment direction F of the casing 1 as shown in FIG. 15B.

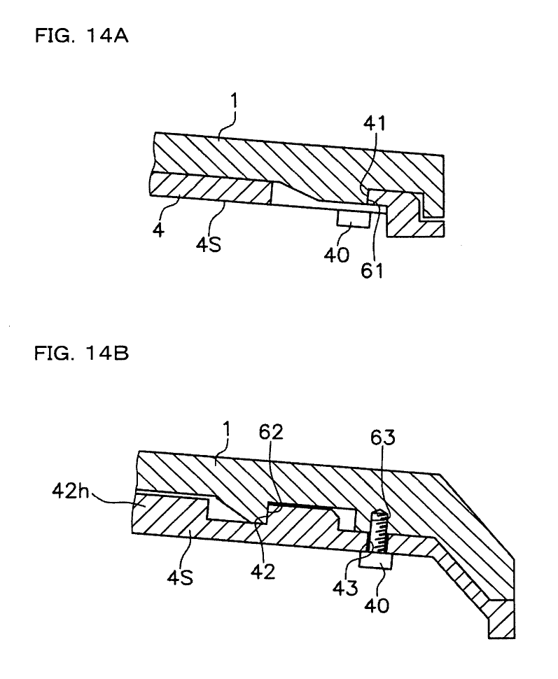

Once the cover 4 is pushed in the attachment direction F, the cover 4 advances in the attachment direction F with the both side portions 4S of the cover 4 in U-shape slightly expanding due to the elasticity of the resin. Then, the first engagement portion 41 shown in FIG. 14A is engaged with the first engaging portion 61, and the second engagement portion 42 shown in FIG. 14B is engaged with the second engaging portion 62. The first engagement portion 41 and the second engagement portion 42 are provided on each of the side portions 4S of the cover 4, and respectively engage with the first engaging portion 61 and the second engaging portion 62 provided on the respective sides of the casing 1. Accordingly, as shown in FIG. 15B, the front portion 4F of the cover 4 is brought into contact with the casing 1 with the sealing member 6 being compressed in the attachment direction F of attaching the cover 4 to the casing 1, that is, with closely attaching to the sealing member 6.

Thus, the first engagement portion 41, the first engaging portion 61, the second engagement portion 42, and the second engaging portion 62 constitute engagement units, by which the cover 4 is engaged with the casing 1 with the sealing member 6 being compressed in the attachment direction F of attaching the cover 4 to the casing 1.

After the engagement, the screw members 40 are inserted through the screw holes 43, and the screw members 40 are threaded into the female screws 63, 64 respectively provided for the both sides of the casing 1. Then, as shown in FIG. 15C, the sealing member 6 is compressed between the casing 1 and the cover 4 by fastening the cover 4 from the sides S that are substantially perpendicular to the attachment direction F.

Although the engagement units 41, 42, 61, 62 in FIG. 11 are provided in vicinity of the both ends of the cover 4 in U-shape in the present embodiment, the engagement units can be provided at any positions of the side portion 4S, or in vicinity of the both ends of the front portion 4F.

Moreover, as the engagement unit, a protrusion can be provided for the cover 4, and a depression can be provided for the casing 1. Further, if the both ends of the cover 4 are formed so as to engage with the rear cover 1b, it is not necessary to provided a depression for the casing 1.

In the present embodiment, the screw member 40 is inserted and compressed from the sides S in the direction perpendicular to the attachment direction F of the cover 4 of FIG. 3. However, the direction of the insertion and compression of the screw member 40 is sufficient if it is different from the attachment direction F. Moreover, it is not necessary that the fixation portion and the fixing member are provided at the upper portion and the lower portion in pairs. For example, the cover 4 can be fixed to the casing 1 by inserting the screw member 40 on a diagonally forward side of a slanted portion in vicinity of the both ends of the cover 4 and denoted by a reference symbol 400 in FIG. 3.

### INDUSTRIAL APPLICABILITY

The present invention can be used for a light scanning photoelectric switch.

What is claimed is:

1. A light scanning photoelectric switch, comprising:
a light scanning unit that rotates about a predetermined axis and scans scanning light over a detection area;
a photoelectric transducer that receives the scanning light reflected on an object within the detection area, and generates a light receiving signal corresponding to the received scanning light;
a recognition unit that calculates an irradiation direction of the received scanning light and a distance to the object based on the light receiving signal for the irradiation direction, and recognizes a position of the object based on the calculated irradiation direction and distance;
a determination unit that determines whether or not the object is present within a predetermined protection area, and outputs a safety signal based on a result of the determination;
a casing that contains the light scanning unit and the photoelectric transducer and includes an optical path of the scanning light from the light scanning unit to the detection area, the casing having an opening substantially in U-shape in cross section perpendicular to the axis;
a cover that is detachably provided for the casing and is for covering the opening of the casing;
an elastically deformable sealing member that is provided between the casing and the cover;
an engagement unit formed at the cover and the casing so that the cover engages with the casing in a state in which the sealing member is compressed in an attachment direction along which the cover is attached to the casing; and
a fixation portion capable of receiving a fixing member that compresses the sealing member in a direction different from the attachment direction in a state in which the cover engages with the casing.

2. The light scanning photoelectric switch according to claim 1, wherein
the cover includes a front portion that is substantially semicircular in cross section and a pair of side portions continuous from the front portion, and the engagement unit is formed at each of the side portions.

3. The light scanning photoelectric switch according to claim 2, wherein
the fixation portion is formed at each of the side portions.

4. The light scanning photoelectric switch according to claim 2, wherein
the cover is substantially in U-shape in cross section, and the fixation portion is formed in vicinity of either end of the substantial U-shape.

5. The light scanning photoelectric switch according to claim 2, wherein
in a state in which the cover is not fixed by the fixing member, both of the side portions of the cover are pressed against the sealing member in the different direction.

6. The light scanning photoelectric switch according to claim 2, wherein
first and second flanges for improving bending rigidity of the cover are formed respectively in vicinity of first and second ends of the axis of the cover, and a portion of the engagement unit is formed at the cover by cutting out the flange or the side portion near the flange.
